(19) United States
(12) Patent Application Publication
(10) Pub. No.: US 2001/0018807 A1
(43) Pub. Date: Sep. 6, 2001

(54) Reusable greeting card

(76) Inventor: Michel Proulx, Stratford (CA)

Correspondence Address: MCDERMOTT, WILL & EMERY, 600 13th Street, N.W., Washington, DC, 20005-3096, US

(21) Appl. No.: 09/796,672

(22) Filed: Mar. 2, 2001

(30) Foreign Application Priority Data
Mar. 3, 2000 (CA) 2,300,591

(51) Int. Cl. G09F 1/00

(52) U.S. Cl. 40/124.01

(57) ABSTRACT

A reusable greeting card having a sheet member and a cover member. The sheet member being adapted to be temporarily secured to the cover member thereby allowing the sheet member to be detached therefrom and reattached or allowing a new sheet member to be attached to the cover sheet.

### FIELD OF THE INVENTION

The present invention broadly relates to greeting cards.

### BACKGROUND OF THE INVENTION

There is a large number of greeting cards available on the market and choosing the right one can be long and difficult process. The main factors which motivates a buyer to chose a particular card are the printed indicia found on the cover of the card and the message found inside the card.

A number of greeting cards having different constructions such as those having a removable decal (U.S. Pat. No. 4,200,222) or those having detachable sections (U.S. Pat. No. 4,613,157) have been proposed. However, none of these cards are reusable, in that they may form a completely new card.

### SUMMARY OF THE INVENTION

An object of the present invention is to provide a reusable greeting card.

Another object of the present invention is to provide a kit for creating a reusable greeting card.

Accordingly, the objects of the present invention are achieved by providing a reusable greeting card comprising:

a sheet member having an inner and outer face, and

a cover member having an inner and outer face, the outer face having a front and back sides,

wherein the outer face of the sheet member is adapted to be temporarily secured on the inner face of the cover member.

The present invention is also concerned with a kit for creating a reusable greeting card, the kit comprising:

at least one cover member, each of the at least one cover member having an inner and outer face, each of the at least one cover member further having a front and back sides, and

at least one sheet member, each of the at least one sheet member having an inner and outer face, each of the at least one sheet member being adapted to be temporarily secured to the inner face of each cover member,

wherein the greeting card is created by combining a pre-selected sheet member to a pre-selected cover member and temporarily securing them together.

The invention further provides a method for creating a reusable greeting card, the method comprising the steps of:

a) selecting a cover member having an inner and outer face, the outer face having a front and back sides;

b) selecting a sheet member having an inner and outer face, the sheet member being adapted to be temporarily secured to the inner face of the cover sheet; and

c) securing the outer face of the sheet member on the inner face of the cover member.

The present invention provides an easy and fast way of creating a greeting card which is reusable.

Another advantage of the present invention is that the kit according to the invention allows room saving since the sheet members are stored in a binder. Hence there is no need to produce a plurality of cards having the same message but a different cover.

### BRIEF DESCRIPTION OF THE DRAWINGS

FIG. 1 is a front perspective view of a reusable greeting card according to a preferred embodiment of the present invention.

FIG. 2 is a perspective view of a sheet member according to a preferred embodiment of the present invention.

FIG. 3 is a schematic view of a kit for creating a reusable greeting card according to a preferred embodiment of the present invention.

### DETAILED DESCRIPTION OF THE INVENTION

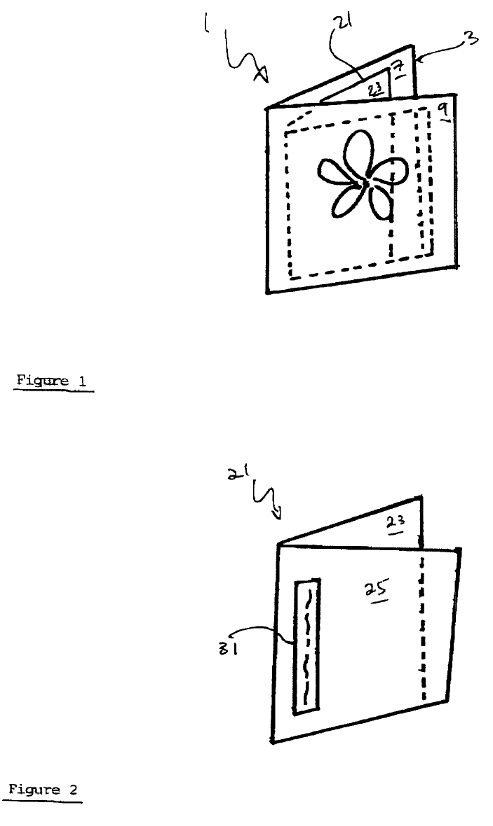

As can be seen in FIG. 1, the present invention is concerned with a reusable greeting card 1. In accordance with the invention, the greeting card 1 comprises a sheet member 21 and a cover member 3. The cover member 3 has an inner and outer face 5,7. The outer face 5 of the cover member 3 further comprises a front and back sides 9, 11 which define the front and back sides of the greeting card 1.

In a preferred embodiment, the cover member 3 is provided with an indicia on at least the font side 9. In the context of the present invention, indicia includes any illustration, emblem, writing, greeting, wish or poem. The indicia may also be an ornamental feature which forms a separate or integral part of the outer face of the cover member. It may further be a textural aspect of the material by which the cover member is formed.

In another preferred embodiment, the front side 9 of the cover member 3 may be blank so to allow a person to execute an artistic work thereon such as, a painting.

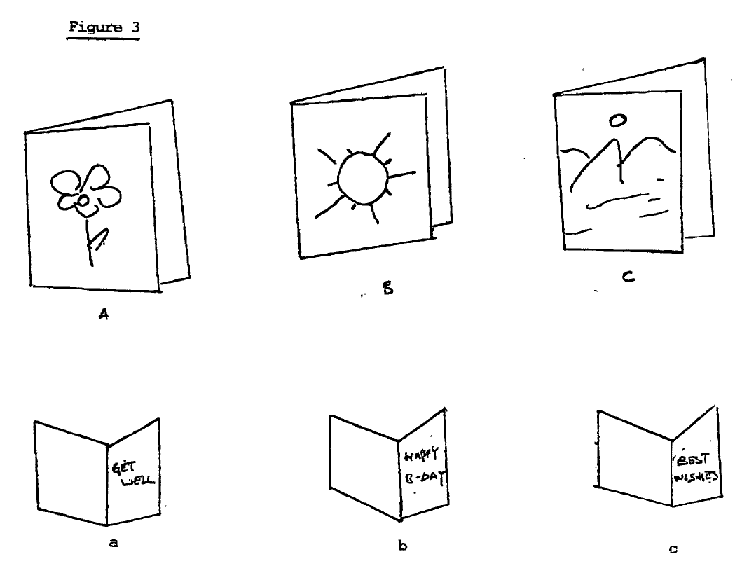

As seen in FIG. 2, the sheet member 21 has an inner and an outer faces 23, 25. The outer face 25 of the sheet member 21 is adapted to be temporarily secured to the inner face 7 of the cover member 3. In the context of the present invention, the term “temporarily” signifies that the sheet member 21 is removably secured to the cover member 3 so as to be detachable from the latter. Hence, it is possible to reattach the same sheet member to the cover member or to the attach a completely different and new sheet member on the cover sheet.

As further seen in FIG. 2, the outer face 25 of the sheet member 21 comprises a bonding surface for allowing it to stick on the inner face 7 of the cover member 3. Preferably, the bonding surface comprises a non-permanent self-adhesive glue. In the illustrated embodiment, the glue forms a vertical strip 31 which extends parallel and next to the folding line of the greeting card 1. However, it will be apparent that other configuration are well within the scope of the present invention.

Preferably, the glue strip 31 is placed on the outer face 25 of the sheet member 21 so as to stick on the front side portion of the cover member 3. Preferably, the non permanent self-adhesive glue is a double stick tape. In storage, the double stick tape is provided with a protective liner (not shown) which is torn away when the sheet member 21 is secured on the cover member 3.

Hence, it is possible to interchange for a same cover member 3, different sheet members 21 which contain different messages, without damaging the cover member 3.

Referring now to FIG. 3, the present invention is also concerned with a kit for creating a greeting card. The kit comprises at least one cover member (A, B, C) and at least one sheet member (a, b, c). Thus it is possible to form a greeting card by first selecting a cover member and then a sheet member containing the appropriate message. It should be understood that a blank sheet member may be used just as well. Then, the selected sheet member is temporarily secured on the cover member thereby forming the card.

In a preferred embodiment of the kit of the present invention, the sheet members are indexed in a binder and the cover members are displayed on a shelf. To form a card, the person only needs to first look over the binder, select the sheet member and then look over the cover member displayed on the shelf and choose the appropriate one. Of course, the order of selection is not important.

It is believed that the reusable card according to the present invention is highly efficient and more environmentally friendly since it allows direct recycling of the components of the card such as the cover member by directly reusing them.

Although the present invention has been explained hereinabove by way of a preferred embodiment thereof, it should be pointed out that any modifications to this preferred embodiment within the scope of the present description is not deemed to alter or change the nature and the scope of the present invention.

1. A reusable greeting card comprising:
a sheet member having an inner and outer face, and
a cover member having an inner and outer face, the outer face having a front and back sides,
wherein the outer face of the sheet member is adapted to be temporarily secured on the inner face of the cover member.

2. A reusable greeting card according to claim 1, wherein at least the front side of the cover member comprises an indicia.

3. A reusable greeting card according to claim 1, wherein the outer face of the sheet member comprises a bonding surface.

4. A reusable greeting card according to claim 3, wherein the bonding surface comprises a self-adhesive glue.

5. A reusable greeting card according to claim 4, wherein the self-adhesive glue is a double stick tape having the form of a vertical strip.

6. A reusable greeting card according to claim 5, wherein the vertical strip extends parallel and along the folding line of the outer face of the sheet member so as to stick on the front portion of the cover member.

7. A reusable greeting card according to claim 1, wherein the inner face of the sheet member comprises printed indicia.

8. A kit for creating a reusable greeting card, the kit comprising:
at least one cover member, each of the at least one cover member having an inner and outer face, each of the at least one cover member further having a front and back sides, and
at least one sheet member, each of the at least one sheet member having an inner and outer face, each of the at least one sheet member being adapted to be temporarily secured to the inner face of each cover member,
wherein the greeting card is created by combining a pre-selected sheet member to a pre-selected cover member and temporarily securing them together.

9. A kit according to claim 8, wherein at least the front side of the cover member comprises an indicia.

10. A kit according to claim 8, wherein the outer face of the sheet member comprises a bonding surface.

11. A kit according to claim 8, wherein the bonding surface comprises a non-permanent self-adhesive glue.

12. A kit according to claim 11, wherein the self-adhesive glue is a double stick tape having the form of a vertical strip.

13. A kit according to claim 12, wherein the vertical strip extends parallel and along the folding line of the outer face of the sheet member so as to stick on the front portion of the cover member.

14. A kit according to claim 8, wherein the inner face of the sheet member comprises a printed indicia.

15. A method for creating a reusable greeting card, the method comprising the steps of:
a) selecting a cover member having an inner and outer face, the outer face having a front and back sides;
b) selecting a sheet member having an inner and outer face, the sheet member being adapted to be temporarily secured to the inner face of the cover sheet; and
c) securing the outer face of the sheet member on the inner face of the cover member.

16. A method according to claim 15, wherein in step c), the sheet member is temporarily secured to the cover member by providing the outer face of the sheet member with a bonding surface.

17. A method according to claim 16, wherein the bonding surface comprises a non permanent self-adhesive glue.

18. A method according to claim 17, wherein the self-adhesive glue is a double stick tape having the form of a vertical strip.

19. A method according to claim 18, wherein the vertical strip extends parallel and along the folding line of the outer face of the sheet member so as to stick on the front portion of the cover member.
